(19) United States
(12) Patent Application Publication
(10) Pub. No.: US 2006/0044472 A1
(43) Pub. Date: Mar. 2, 2006

(54) Method of controlling display apparatus

(76) Inventors: Sung-hee Lee, Suwon-si (KR); Oh-jae Kwon, Anyang-si (KR)

Correspondence Address: Stanzione & Kim, LLP, Suite 440, 919 18th Street, NW, Washington, DC, 20006, US

(21) Appl. No.: 11/213,756

(22) Filed: Aug. 30, 2005

(30) Foreign Application Priority Data
Aug. 30, 2004 (KR) 2004-68429

(51) Int. Cl. H04N 5/21

(52) U.S. Cl. 348/607

(57) ABSTRACT

A method of controlling a display apparatus displaying a plurality of frame images sequentially, the method includes detecting whether the sequential frame images in the plurality of frame images have a blurry image area or a non-blurry image area, and interposing an intermediate frame image between the respective sequential frame images by inserting an image having pixel values lower than pixel values of the sequential frame images in the blurry image area, and by inserting an image having either the pixel value of one of the sequential frame images, or an average pixel value of the sequential frame images in the non-blurry image area. The method of controlling a display apparatus eliminates a motion-blur effect without deteriorating brightness.

### CROSS-REFERENCE TO RELATED APPLICATIONS

This application claims the benefit under 35 U.S.C. §119 of Korean Patent Application No. 2004-68429, filed on Aug. 30, 2004, in the Korean Intellectual Property Office, the disclosure of which is incorporated herein in its entirety and by reference.

### BACKGROUND OF THE INVENTION

1. Field of the Invention

The present general inventive concept relates to a method of controlling a display apparatus, and more particularly, to a method of controlling a display apparatus to eliminate a motion-blur effect without deteriorating brightness.

2. Description of the Related Art

A display apparatus is classified into an impulse type or a hold type according to displaying methods.

The impulse type uses a method allowing respective pixels to instantly emit light as bright as needed to display a picture. An example of an impulse type display apparatus is a cathode ray tube (CRT) display apparatus.

The hold type uses a method allowing the respective pixels to emit light for a predetermined period of time as bright as needed to display a picture (refer to FIG. 1). FIG. 1 is a graph illustrating a displaying method of a conventional hold type display apparatus. An example of a hold type display apparatus is a liquid crystal display (LCD) apparatus.

Generally, the impulse type and the hold type are different in performance of displaying a motion picture.

In a case in which the moving picture moves as time passes, a human's eye perceives that the moving picture displayed on the hold type display apparatus is more blurred than that on the impulse type display apparatus.

The reason why the hold type display apparatus blurs the moving picture displayed thereon more than the impulse type display apparatus is that an afterimage persisted by an integral in a human's brain is diminished in the case of the impulse type display apparatus because the impulse type display apparatus instantly emits light, but the afterimage is enhanced in the case of the hold type display apparatus because the hold type display apparatus emits light for a predetermined period of time.

Thus, to improve the hold type display apparatus in the performance of displaying a moving picture, an impulse type driving method similar to a CRT displaying method has been applied to the hold type display apparatus.

To apply the impulse type driving method to the hold type display apparatus, a black frame image is interposed between sequential frame images as shown in FIG. 2. FIG. 2 is a graph illustrating an impulse type driving method applied to the conventional hold type display apparatus.

However, in the impulse type driving method applied to the hold type apparatus, the black frame image is always interposed between the sequential frame images regardless of a motion image area or a still image area, so that the brightness of a screen is decreased.

### SUMMARY OF THE INVENTION

Accordingly, the present general inventive concept provides a method of controlling a display apparatus, which eliminates a motion-blur effect without deteriorating brightness.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of controlling a display apparatus displaying a plurality of frame images sequentially, the method comprising detecting whether the sequential frame images of the plurality of frame images have a blurry image area or a non-blurry image area, and interposing an intermediate frame image between the respective sequential frame images by inserting an image having pixel values lower than pixel values of the sequential frame images in the blurry image area, and by inserting an image having either the pixel value of one of the sequential frame images, or an average pixel value of the sequential frame images in the non-blurry image area.

The detecting of whether the sequential frame images have the blurry image area or the non-blurry image area may be based on whether a motion of an image is contained between the sequential frame images.

The detecting of whether the sequential frame images have the blurry image area or the non-blurry image area on the basis of whether the motion of the image is contained between the sequential frame images, may comprise calculating a difference between the pixel values of the sequential frame images, accumulating the differences between the pixel values in a predetermined area, and determining the predetermined area as the blurry area when a cumulative value of the differences between the pixel values is higher than a predetermined critical value, and as the non-blurry area when the cumulative value of the differences between the pixel values is equal to or lower than the critical value.

The critical value may vary according to an amount of noise or a gradient of the frame images.

The critical value may be increased when the image includes a large amount of noise or the gradient thereof is large, and decreased when the image includes a small amount of noise or the gradient thereof is small.

The interposing of the intermediate frame image may comprise inserting a black image when the image having the pixel values lower than the pixel values of the sequential frame images is inserted in the blurry image area.

The inserting of the black image may comprise processing with a black mask.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a graph illustrating a displaying method of a conventional hold type display apparatus;

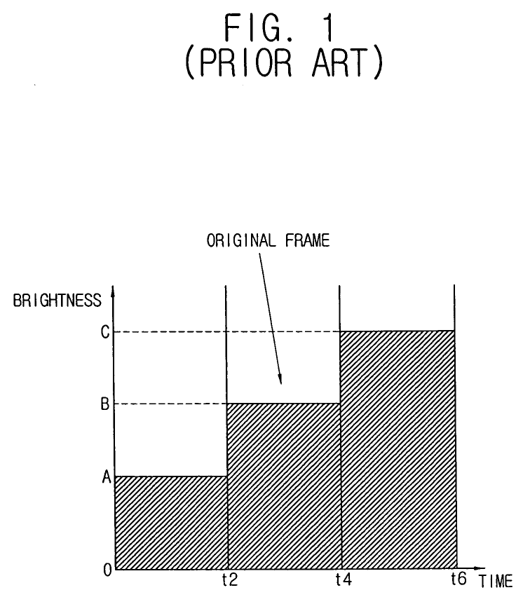

FIG. 2 is a graph illustrating an impulse type driving method applied to the conventional hold type display apparatus;

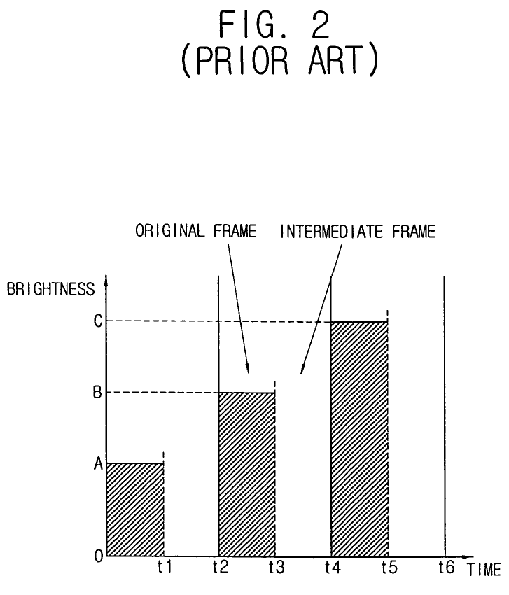

FIG. 3 is a control flowchart of a display apparatus according to an embodiment of the present general inventive concept;

FIG. 4 illustrates that a motion image area and a still image area are divided according to an embodiment of the present general inventive concept;

FIG. 5 is a graph illustrating a displaying method in a non-blurry image area (or a still image area) according to an embodiment of the present general inventive concept; and

FIG. 6 is a graph illustrating a displaying method in a blurry image area (or a motion image area) according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures.

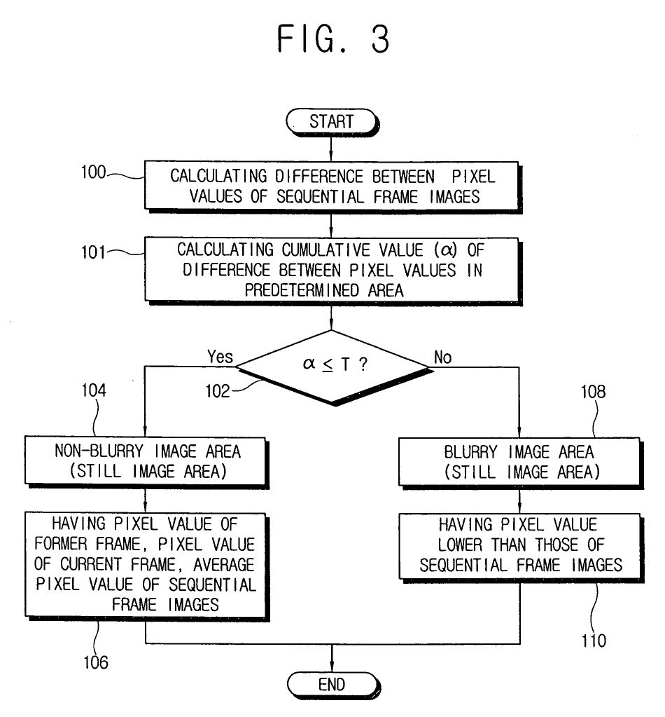

FIG. 3 is a control flowchart of a display apparatus according to an embodiment of the present general inventive concept.

Generally, a motion-blur occurs while a moving picture is displayed, and does not occur while a still picture is displayed. Therefore, a motion detecting method is used to determine whether the motion-blur happens or not. To detect motion of an image, a cumulative value a of differences e between pixel values in a predetermined area B is calculated by the following equations (1) and (2).

$$\begin{matrix}ɛ = \vert f ( x , n - 1 ) - f ( x , n ) \vert & ( 1 ) \\ α = {\sum }_{x ∈ B} ɛ & ( 2 )\end{matrix}$$

At operation 100, the difference e between the pixel values f(x,n−1), f(x,n) of two sequential frame images are calculated by the equation (1). At operation 101, the differences e between the pixel values in the predetermined area B are accumulated by the equation (2), thereby calculating the cumulative value a of the differences e between the pixel values in the area B.

Here, the cumulative value a of the differences e between the pixel values in the area B is employed as a reference to determine whether the area B is a still image area or a motion image area.

An input frame image is determined as the motion image area or the still image area on the basis of the following equation (3).

$$\begin{matrix}Type = non \text{-} blurry image area ( or still image area ) , \\ if a \leq T \\ = blurry image area ( or motion image area ) , \\ otherwise\end{matrix} \\ where T is a critical value . \qquad ( 3 )$$

At operation 102, the display apparatus according to the embodiment of FIG. 3 compares the cumulative value a of the differences e between the pixel values in the predetermined area B with the critical value T When the cumulative value a of the differences e between the pixel values in the predetermined area B is equal to or lower than the critical value T, at operation 104, it is determined that the pixels in the area B are in the still image area. On the other hand, when the cumulative value a of the differences e between the pixel values in the predetermined area B is higher than the critical value T, at operation 108, it is determined that the pixels in this area B are in the motion image area.

Because the motion blur depends on the motion of the image, the pixels in the still image area are determined to be in the non-blurry image area, and the pixels in the motion image area are determined to be in the blurry image area.

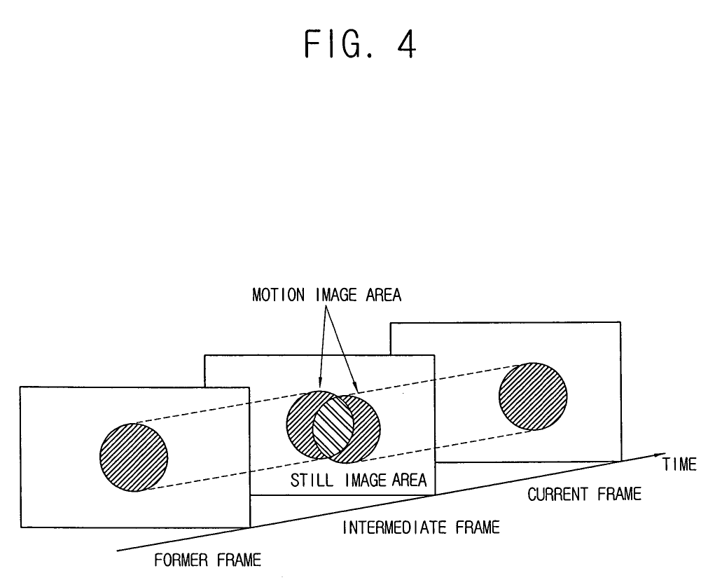

According to an embodiment of the present general inventive concept, as illustrated in FIG. 4, an intermediate frame is interposed between sequential frames (i.e., a former frame and a current frame), wherein the intermediate frame includes the blurry image area (i.e., motion image area) and the non-blurry image area (i.e., still image area).

In the case of the non-blurry image area of the intermediate frame, at operation 106, pixels in the non-blurry image area of the intermediate frame can be controlled to have pixel values corresponding to pixel values of the non-blurry image area in either of the two sequential frames (i.e., the former and current frames). Alternatively, at operation 106, the pixels in the non-blurry image area of the intermediate frame can be controlled to have the pixel values corresponding to an average of the pixel values of the non-blurry image areas of the two sequential frames (i.e., the former and current frames).

In the case of the blurry image area of the intermediate frame, at operation 110, pixels in the blurry image area of the intermediate frame are controlled to have pixel values lower than pixels values of the blurry image area in the two sequential frames (i.e. the former and current frames). In this case, a black image can be inserted on the blurry image area.

Meanwhile, the cumulative value a of the differences e between the pixel values in the predetermined area B may be affected by an amount of noise or by a gradient of an image. That is, in a case in which the amount of noise or the gradient of the image is large, even though the pixels are not in the motion image area, the pixels can be determined to be in the motion image area because the difference e between the pixel values in the sequential frame increases.

Therefore, the critical value T varies according to the amount of noise or the gradient of the image. For example, the critical value T can be increased when the image includes a large amount of noise or a large gradient, like an image containing many edges. In contrast, the critical value T can be decreased when the image includes a small amount of noise or a small gradient, like an image containing few edges.

According to an embodiment of the present general inventive concept, the critical values T are predetermined and stored as a table, and the amount of noise and the gradient of the image are measured whenever the frame image is input, so that the critical value T can be set as a value of the table corresponding to the measured data.

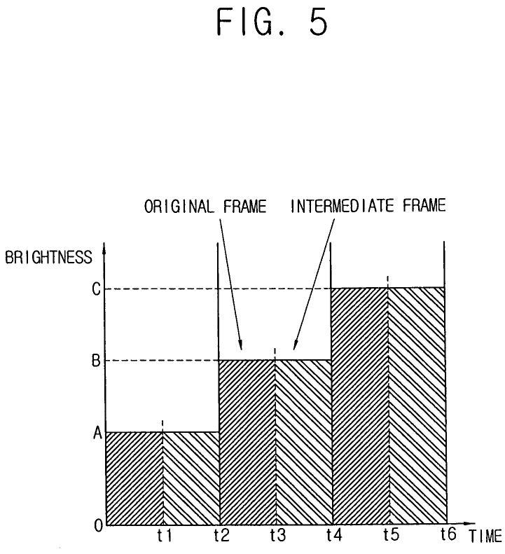

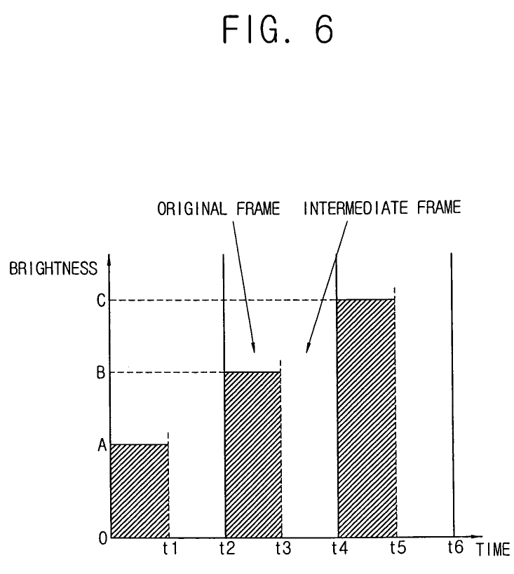

FIG. 5 is a graph illustrating image insertion in the non-blurry image area, and FIG. 6 is a graph illustrating image insertion in the blurry image area.

As shown in FIG. 5, the non-blurry image area of the intermediate frame has the same pixel values (i.e. brightness) as a corresponding area in an original frame. Alternatively, the non-blurry image area of the intermediate frame may have the average pixel values of the corresponding areas of the two sequential frames, or the same pixel values as the corresponding area in either of the two sequential frames. Thus, brightness is not deteriorated in the non-blurry image area.

As shown in FIG. 6, the black image can be inserted in the blurry image area of the intermediate frame, to thereby eliminate a motion-blur effect. Here, a black mask processing method can be used as a method of inserting the black image.

Alternatively, an image that is not a black image having pixel values lower than the pixel values of the blurry image area in the two sequential frames can be inserted in the blurry image area of the intermediate frame.

As described above, the image having the pixel values lower than the pixel values of the sequential frames is inserted in the blurry image area detected by the motion detecting method, and the image having either the pixel values of one of the sequential frames, or the average pixel value of the sequential frames is inserted in the non-blurry image area detected by the motion detecting method, so that the images of the intermediate frame are interposed between the images of the respective sequential frames, thereby eliminating a motion-blur effect without deteriorating brightness.

As described above, the present general inventive concept provides a method of controlling a display apparatus, which eliminates a motion-blur effect without deteriorating brightness.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of controlling a display apparatus displaying a plurality of frame images sequentially, the method comprising:
detecting whether sequential frame images of the plurality of frame images have a blurry image area or a non-blurry image area; and
interposing an intermediate frame image between the respective sequential frame images by inserting an image having pixel values lower than pixel values of the sequential frame images in the blurry image area, and by inserting an image having either the pixel value of one of the sequential frame images, or an average pixel value of the sequential frame images in the non-blurry image area.

2. The method according to claim 1, wherein the detecting of whether the sequential frame images have the blurry image area or the non-blurry image area is based on whether a motion of an image is contained between the sequential frame images.

3. The method according to claim 2, wherein the detecting of whether the sequential frame images have the blurry image area or the non-blurry image area on the basis of whether the motion of the image is contained between the sequential frame images, comprises:
calculating differences between the pixel values of the sequential frame images;
accumulating the differences between the pixel values in a predetermined area; and
determining the predetermined area as the blurry area when a cumulative value of the differences between the pixel values is higher than a predetermined critical value, and as the non-blurry area when the cumulative value of the differences between the pixel values is equal to or lower than the critical value.

4. The method according to claim 3, wherein the critical value varies according to an amount of noise or a gradient of the frame images.

5. The method according to claim 4, wherein the critical value is increased when the image includes a large amount of noise or the gradient thereof is large, and decreased when the image includes a small amount of noise or the gradient thereof is small.

6. The method according to claim 1, wherein the interposing of the intermediate frame image comprises inserting a black image when an image having the pixel values lower than the pixel values of the sequential frame images is inserted in the blurry image area.

7. The method according to claim 6, wherein the inserting of the black image comprises processing with a black mask.

8. A method of controlling a display apparatus displaying an image having sequential frames, the method comprising:
detecting a moving portion and a non-moving portion of the image;
inserting an intermediate frame between the sequential frames;
controlling a brightness of a moving portion of the intermediate frame corresponding to the moving portion of the image according to a brightness of the moving portion of the image; and
controlling a brightness of a non-moving portion of the intermediate frame corresponding to the non-moving portion of the image according to the brightness of the non-moving portion of the image.

9. The method according to claim 8, wherein the detecting of the moving portion and the non-moving portion of the image comprises:
comparing a brightness of an area of the image in the sequential frames to determine a brightness difference; and
comparing the brightness difference to a predetermined critical value.

10. The method according to claim 9, wherein the detecting of the moving portion and the non-moving portion of the image further comprises:
determining that the area is in the moving portion when the brightness difference is greater than the critical value; and
determining that the area is in the non-moving portion when the brightness difference is less than or equal to the critical value.

11. The method according to claim 8, wherein the controlling of the brightness of the moving portion of the intermediate frame comprises:
controlling the brightness of the moving portion of the intermediate frame to be less than a brightness of a moving portion of each of the sequential frames.

12. The method according to claim 8, wherein the controlling of the brightness of the non-moving portion of the intermediate frame comprises: controlling the brightness of the non-moving portion of the intermediate frame to be the same as a brightness of a non-moving portion of one of the sequential frames.

13. The method according to claim 8, wherein the controlling of the brightness of the non-moving portion of the intermediate frame comprises:
controlling the brightness of the non-moving portion of the intermediate frame to be an average of a brightness of a non-moving portion of each of the sequential frames.

14. A method of controlling a display apparatus displaying a plurality of original frame images in a sequence, the method comprising:
comparing each of the plurality of original frame images with surrounding original frame images in the sequence to detect a moving portion and a non-moving portion of each of the plurality of original frame images; and
interposing a plurality of intermediate frame images with the plurality of original frame images in the sequence so that each of the plurality of intermediate frame images is adjacent to a corresponding one of the plurality of original frame images in the sequence.

15. The method according to claim 14, wherein the comparing of each of the plurality of original frame images with the surrounding original frame images comprises:
comparing pixel values in an area of each of the plurality of original frame images with pixel values in a corresponding area of the surrounding original frame images.

16. The method according to claim 14, further comprising:
determining pixel values of each of the plurality of intermediate frame images according to pixel values of the corresponding one of the plurality of original frame images.

17. The method according to claim 16, wherein the determining of the pixel values of each of the plurality of intermediate frame images comprises:
controlling pixel values of a moving portion of each of the plurality of intermediate images to be less than pixel values of the moving portion of the corresponding one of the plurality of original frame images.

18. The method according to claim 17, wherein the determining of the pixel values of each of the plurality of intermediate frame images further comprises:
controlling pixel values of a non-moving portion of each of the plurality of intermediate frame images to be equal to pixel values of the non-moving portion of the corresponding one of the plurality of original frame images.

19. The method according to claim 17, wherein the determining of the pixel values of each of the plurality of intermediate frame images further comprises:
controlling pixel values of a non-moving portion of each of the plurality of intermediate frame images to be equal to an average of pixel values the non-moving portions of the original frame images surrounding the corresponding one of the plurality of original frame images in the sequence.

20. The method according to claim 17, wherein the determining of the pixel values of each of the plurality of intermediate frame images further comprises:
controlling pixel values of a non-moving portion of each of the plurality of intermediate frame images to be equal to pixel values of the non-moving portion of one of the original frame images surrounding the corresponding one of the plurality of original frame images in the sequence.

21. The method according to claim 14, further comprising:
inserting a black image as a moving portion of each of the plurality of intermediate frame images; and
determining pixel values of a non-moving portion of each of the plurality of intermediate frame images according to the pixel values of the non-moving portion of the corresponding one of the plurality of original frame images.

22. The method according to claim 20, wherein the inserting of the black images comprises:
processing with a black mask.
